(19) United States
(12) Patent Application Publication
(10) Pub. No.: US 2025/0328651 A1
(43) Pub. Date: Oct. 23, 2025

(54) VULNERABILITY REMEDIATION FOR DIGITAL CERTIFICATES

(71) Applicant: Nvidia Corporation, Santa Clara, CA (US)

(72) Inventors: Mark Alan Overby, Snohomish, WA (US); Michael Denis O'Connor, San Francisco, CA (US); Robert Earl Nertney, Santa Clara, CA (US)

(21) Appl. No.: 18/639,688

(22) Filed: Apr. 18, 2024

(51) Int. Cl. G06F 21/57; G06F 21/33

(52) U.S. Cl. CPC G06F 21/577; G06F 21/33; G06F 2221/034

(57) ABSTRACT

Systems and methods herein are for a host machine to include memory having instructions and at least one processor to execute instructions, which can cause the host machine to communicate with a verification server using a vulnerability request associated with a digital certificate, which can also cause the host machine to receive and parse a vulnerability response which includes a completion indicator, a status indicator, and an information or reference indicator associated with the status indicator, and which can cause the host machine to use the information or reference indicator to determine or perform a response to a vulnerability associated with the digital certificate.

### TECHNICAL FIELD

At least one embodiment pertains to improving vulnerability disclosures for digital certificates.

### BACKGROUND

Reference Integrity Manifests (RIMs), such as Concise RIM (CoRIM), represent example standards associated with vulnerability disclosures for digital certificates. A status of a digital certificate, such as those associated with CoRIM, may be provided as part of an attestation of the digital certificate. A status of a digital certificate may be provided from authorized measurement values. However, the status may only indicate if a digital certificate has been revoked, is unknown, or is good. In an application instance, a digital certificate may be associated with an application driver used by a party or a platform in a computing system. The party or platform may not be able to immediately use a different driver set associated with a different digital certificate, when an initial driver set associated with an initial digital certificate is determined to be in a revoked status. For example, a status may only be an indication of a good, an unknown, or a revoked status for a certificate. This may represent insubstantial information for certain purposes, including for automation purposes. A result may be that a host machine may not be able to determine to proceed after a vulnerability is indicated based in part on a status received. The host machine may not be able to take a meaningful approach to the vulnerability that may lead to a shutdown or denied access even if the vulnerability is not actually severe.

### BRIEF DESCRIPTION OF DRAWINGS

FIG. 1 illustrates a system that is subject to improvements in vulnerability disclosures for digital certificates, according to at least one embodiment;

FIG. 2 illustrates a transaction flow for vulnerability disclosures for digital certificates using an extension field of a status, according to at least one embodiment;

FIG. 3 illustrates further aspects of a system for vulnerability disclosures pertaining to a graphical processing unit (GPU) using an extension field of a status, according to at least one embodiment;

FIG. 4 illustrates computer aspects for vulnerability disclosures for digital certificates using an extension field of a status, according to at least one embodiment;

FIG. 5 illustrates a process flow for a system for vulnerability disclosures for digital certificates using an extension field of a status, according to at least one embodiment;

FIG. 6 illustrates a further process flow for a system for vulnerability disclosures for digital certificates using an extension field of a status, according to at least one embodiment; and

FIG. 7 illustrates yet another process flow for a system for vulnerability disclosures for digital certificates using an extension field of a status, according to at least one embodiment.

### DETAILED DESCRIPTION

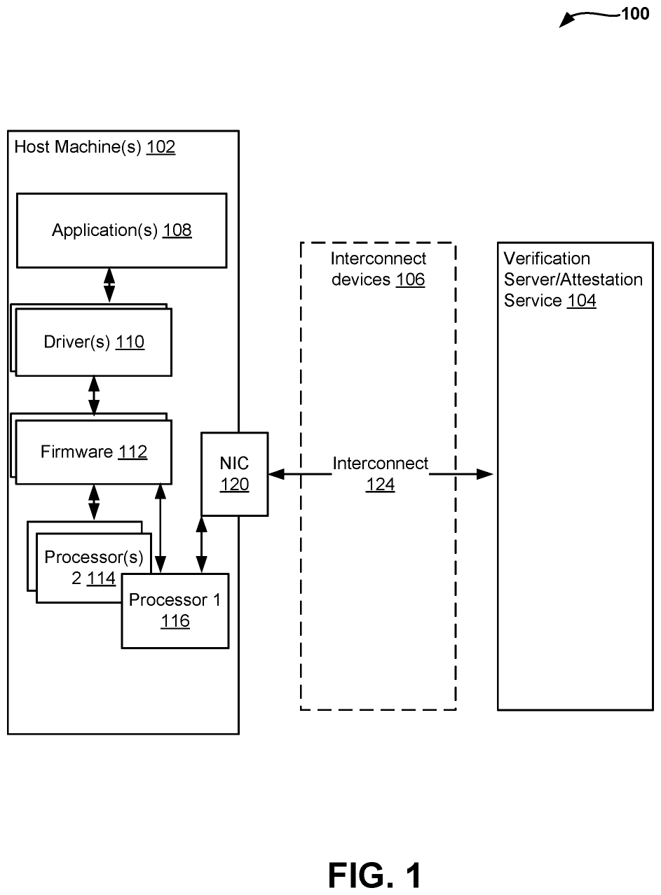

In at least one embodiment, FIG. 1 illustrates a system 100 that is subject to improvements in vulnerability disclosures for digital certificates, as detailed herein. The digital certificates may be associated with security or confidentiality in one or more components of the system 100. In one example, the system 100 may be adapted to International Telecommunication Union's (ITU®) Online Certificate Status Protocol (OCSP) of its X.509 standard or may be adapted to any similar or suitable protocol supporting a vulnerability disclosure, as readily apparent upon reviewing the entire discussion herein. At least OCSP enables a relying party or platform to vulnerability checks or disclosures associated with digital certificates. These vulnerability checks or disclosures may be performed in real-time. In one example, a host machine that is partly in or fully in a cloud environment is able to maintain security of its associated application, hardware, and network resources, by sending a vulnerability request to a verification server, and receiving a vulnerability response. While the vulnerability response may indicate whether to allow or deny attestation of a digital certificate, the status in the vulnerability response may only be good, revoked, or unknown.

To address limitations in a status having only vulnerability responses of good, revoked, or unknown, the system 100 herein may include aspects for improving vulnerability disclosures for digital certificates. In at least one embodiment, the system 100 may be subject to the internet protocol (IP) standard and may incorporate OCSP. However, the system 100 herein can function for improving vulnerability disclosures beyond OCSP. In at least OCSP, an extension field is supported and may be returned in a vulnerability response. The extension field may be used to return vulnerability information or a reference indicator to a host machine 102. The vulnerability information may pertain to a digital certificate associated with at least one of provided drivers 110 or firmware 112 of a processor 2 114, 1 116. The vulnerability information or reference indicator can be used to determine a response to a vulnerability associated with the digital certificate or to modify the digital certificate based in part on communications with a third-party server.

In one example, an application 108 may require use of a processor 2 114, 1 116. A verification may be initially performed for validity or attestation of a driver or a firmware (or any other aspects of a system 100 benefiting therefrom) associated with at least one processor 2 114, 1 116. The attestation may be performed with support from a verification server or attestation service 104, as used interchangeably herein. In one example, the verification server or attestation service 104 may be an OCSP server. Further, the extension field may be used for the improved vulnerability disclosure herein by allowing a verification server 104 to provide information or a reference about the vulnerability along with the verification. The information or reference can be used by a host machine 102 to determine or perform a response to the vulnerability, including to modify the digital certificate. In aspects herein, the host machine 102 is all or partly within a cloud environment. However, the host machine may be a client device benefiting from the improved vulnerability disclosure herein. In any implementation, the host machine 102 may use interconnect devices 106, such as routers, switches, and gateways, to communicate with a verification server 104.

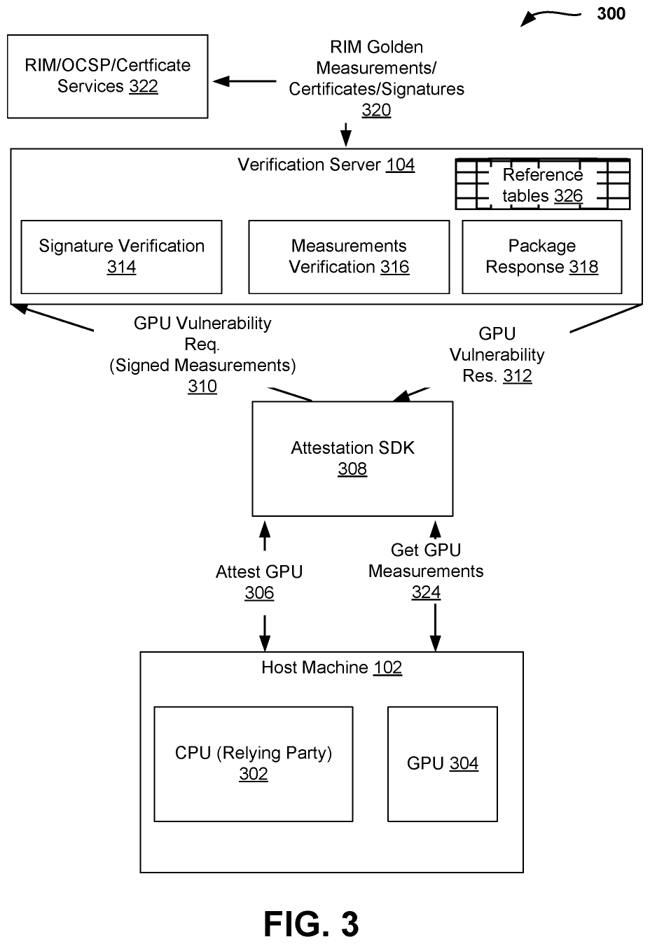

In one example, as detailed further with respect to FIG. 3 herein, a GPU (such as, any one of processors 2 114) may be made a confidential GPU. To do so, the GPU may need to have its drivers 110 and/or firmware 112 attested. The GPU may use its drivers 110 and/or firmware 112 to communicate information, such as measurements pertaining to its digital certificate(s) for the drivers 110 and/or firmware 112, to a CPU (such as, processor 1 116) to enable confidential or other operations using the GPU within a host machine 102. However, the GPU, a CPU, a data processing unit (DPU), or any suitable circuit component that is not necessarily for confidential operations, as readily apparent upon reviewing this entire description, may be subject to attestation associated with a digital certificate. In at least one embodiment, the information provided with a vulnerability request is also referred to herein as evidence, and the measurements, as used herein, is in reference to a hash of one or more states of a component, such as, the drivers 110 and/or firmware 112 of the GPU, or the GPU as a whole. As used herein, therefore, the component subject to vulnerability verification or attestation may be hardware, firmware, or software. In at least one embodiment, the states, as used herein, may be tied to security features associated with the GPU and which may be used to provide a measurement.

In at least one embodiment, a state as used herein may correspond to a status of one or more registers, long term memory, or static random-access memories (SRAMs) within the GPU. Then, a measurement may reflect a hash of the state to provide an overall GPU state that may be a measurement of all features possibly subject to vulnerabilities in the GPU. However, it is also possible to provide measurements only for certain registers that are considered high-value registers, and which may be used to prove a configuration for a confidential computing (CC) of the GPU. Further, it is possible to use policies, errors, and events having association to security or vulnerability as a state which is subject to measurements and attestation. In one example, it is possible to perform cryptographic integrity checks of microcode wholly or partially contained or provided within the trust boundary of the system herein. A hashing microcode and other software/firmware may be deployed within the host machine 102 that may be subject to security checks for vulnerability disclosures using underlying digital certificates, for instance.

The CPU can package, sign, and transmit a vulnerability request which is associated with the measurements for the digital certificate. For example, the CPU transmits the vulnerability request through a network interface card (NIC) 120 and through one or more interconnect devices 106 providing an interconnect 124. The verification server 104 can maintain or retain a database or tables of current measurements (also referred to as golden measurements) associated with current digital certificates. These may be retrieved to or provided to the verification server 104 from manufacturers of components and devices to be used by one or more host machines. The verification server 104 can receive the vulnerability request after verification of the signature from the host machine and can determine a status of the digital certificate.

The verification server 104 can provide a vulnerability response, via the interconnect 124, that may include a completion indicator, a status indicator, and an information or reference indicator associated with the status indicator. The completion indicator may include a success indication that the vulnerability request is successfully addressed. The status indicator may include a good, unknown, or revoked indication with respect to the digital certificate. However, the information or reference indication may include a bulletin information extension field within the vulnerability response. The bulletin information allows the host machine to use the information or reference indicator to determine or perform a response to a vulnerability associated with the digital certificate.

In at least one embodiment, the response may include to use a different digital certificate, to not proceed with a workload or job that triggered the vulnerability request, or to modify the digital certificate based in part on communications with a third-party server. In one example, a hyperlink for bulletin information may be in the extension field to provide access to a security bulletin associated with the unknown or revoked status of the digital certificate. Further, a different hyperlink that may be associated with the bulletin information in the extension field and can provide access to a package of an updated digital certificate to be used to modify the digital certificate.

In at least one embodiment, such approaches of providing vulnerability disclosures for digital certificates using an extension field also includes providing the host machine 102 with an ability to recognize the extension field and to parse the extension field to be able to access information from a third-party server and to respond to the vulnerability. Under attestation, a status of the certificate for the CoRIM, which provides the authorized measurements, may now include relevant information passed to the relying party and enables a relying party or platform to autonomously determine or perform a risk decision. This includes an ability to directly secure a package from a third-party server to cause remediation of an underlying issue that caused the unknown or revocation status for a digital certificate.

In an example that may be specific to OCSP, an OCSP extension may be defined such that when a revoked or unknown status is returned in a vulnerability response by a verification server capable of OCSP support, a uniform resource identifier (URI) or other hyperlink may be included in the OCSP extension. The URI or other hyperlink may enable a host machine 102 to be redirected to a standardized XML® or a standardized JSON® format script, which may include a description of each common vulnerability and exposure (CVE). Further, the host machine, as a relying party or platform, can autonomously parse the CVE for relevant information to respond with a risk decision. The risk decision may include ignoring the revocation or unknown status and continue with using the underlying component (such as, the driver, the firmware, or the GPU as a whole). The risk decision may be to obtain a package of remediated software and to execute or apply the package to perform modification of the digital certificates. Alternatively, the response may be to terminate use of the underlying component, including any processing currently performed with the underlying component.

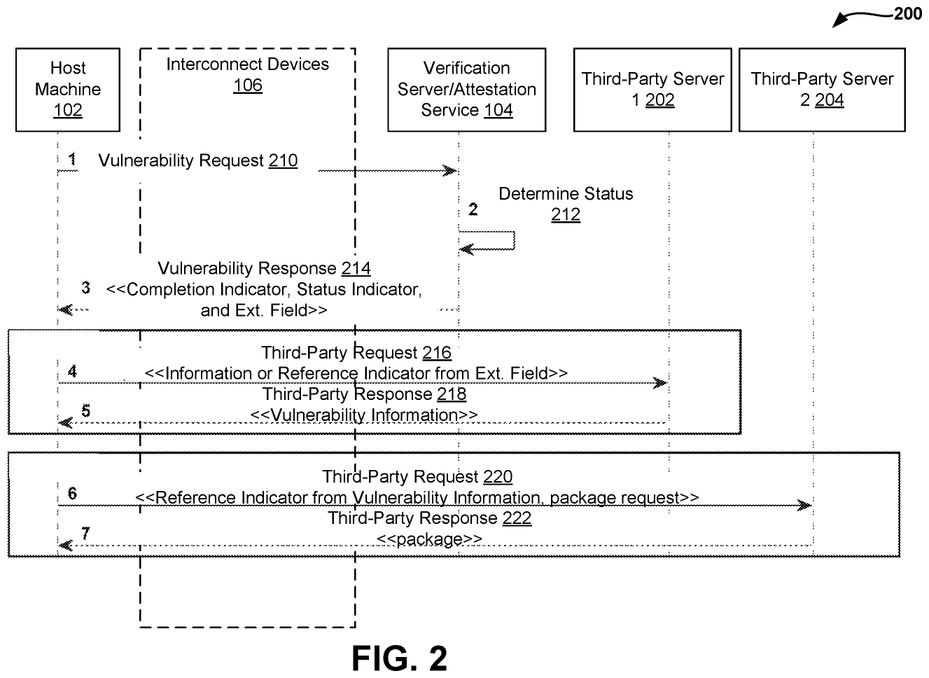

FIG. 2 illustrates a transaction flow 200 for vulnerability disclosures for digital certificates using an extension field of a status, according to at least one embodiment. A host machine 102 having memory and at least one processor 2 114; 1 116 may execute instructions from the memory to cause the host machine 102 to communicate with a verification server 104 using a vulnerability request 210. The vulnerability request 210 may be associated with a digital certificate, as detailed herein at least with respect to FIG. 1. The verification server 104 may perform its verification processes to determine 212 a status of the digital certificate. The verification processes are detailed further herein with respect to at least FIG. 3. The verification server 104 can provide a vulnerability response 214 to the host machine 102. The host machine 102 receives and parses the vulnerability response 214. The host machine may include instructions associated with at least a CPU of the processors 2 114; 1 116 to perform the parsing of the vulnerability response 214. Particularly, the host machine 102 is able to appreciate contents of the vulnerability response, including in an extension field of the vulnerability response 214. The vulnerability response 214 may include a completion indicator, a status indicator, and an information or reference indicator associated with the status indicator. At least the information or reference indicator is in an extension field of the vulnerability response 214.

Separately, the completion indicator may include a success or failed notification. The completion indicator may include a good, unknown, or revoked indicator. In at least one embodiment, the extension field may include a SEQUENCE SIZE to indicate to the host machine 102 the size of the extension field. The extension field may include a sequence of values providing an OBJECT IDENTIFIER and a critical value that may be a Boolean and that may be defaulted to a FALSE value. Further, the information or reference indicator may be included in the sequence as part of an OCTET STRING. In at least one embodiment, the extension field may be in a binary encoding format, such as, in Distinguished Encoding Rules (DER) format. Further, one or more of the sequence values may be optional. As such, a host machine 102 may not be required to understand any specific sequence value unless provided with capabilities to parse one or more of such sequence values of an extension field.

In at least one embodiment, the extension field may be only provided in a vulnerability response 214 when a digital certificate has been revoked because, in part, the revocation may represent an identity benefiting from the OBJECT IDENTIFIER and any subsequent sequence values. In at least one embodiment, a RIM or a certificate may be used to sign code or similar constructs that may be provided in or referenced in the OCTET STRING. For example, an extension field may be prepared in response to a revocation using an OBJECT IDENTIFIER, such as, id-pkix-ocsp-bulletin. Then, sequence values may be included as a BulletinInfo construct. The BulletinInfo construct may include at least one reference indicator uriBulletin. However, the BulletinInfo construct may include a second reference indicator for a package to replace the existing driver or firmware, for instance. The BulletinInfo construct for this second reference indicator may be uriReplacement. One or more of reference indicators may comply with the RFC 3986 standard.

In at least one embodiment, the uriReplacement of the sequence values may be provided in a subsequent communication rather than in an extension field that includes the uriBulletin reference indicator. For example, the host machine 102 may use the uriBulletin reference indicator to perform a first third-party request 216. The uriBulletin may direct the host machine 102 to an XML file. In an example, the uriBulletin reference indicator may be https://example.com/bulletin-1282.xml of the first third-party request 216 and may direct the host machine 102 to a first third-party server 1 202 hosting the 1282.xml file. This first third-party server 1 202 may provide a first third-party response 218 with vulnerability information. This vulnerability information may include a second reference indicator, such as, uriReplacement.

In at least one embodiment, the second reference indicator may cause the host machine 102 to be directed to a second third-party server 2 204 or to the same third-party server 1 202, via a second third-party request 220. In either case, the second reference indicator, uriReplacement may be from the first third-party response 218. The second reference indicator may be https://example.com/newdriver-1282.tar of the second third-party request 220 and may direct the host machine 102 to a second third-party server 2 204 (or the same first third-party server 1 202), which hosts the 1282 tar package. This third-party server 1 202; 2 204 may provide a second third-party response 222 with the Tar® package.

In at least one embodiment, the host machine 102 is, therefore, able to use the information or reference indicator to determine a response to a vulnerability associated with the digital certificate or to modify the digital certificate based in part on communications with a third-party server. The response may be to not perform any further action (not use the existing digital certificate), to continue a prior action (such as, using the existing digital certificate and, therefore, the existing driver, firmware, or GPU configuration), or to continue a prior action using a specific one of existing driver, firmware, or GPU configuration of available drivers, firmware, or GPU configurations. For the modification to the digital certificate, the host machine 102 is able to use the received package (in tar or any suitable format) to apply a new driver, firmware, or other GPU configuration. In at least one embodiment, while illustrated as distinct first and second third-party requests and responses, these may be enabled by one or two responses 214; 218. In at least one embodiment, there is no restriction on contents of the reference indicators uriBulletin and uriReplacement. Further, it may be appreciated that uriBulletin uses a standardized format of communicating CVEs associated with a revocation in an XML format, for instance; however, that other formats, including MITRE® (from the MITRE Corporation) or National Vulnerability Database (NVD®), may be used.

In one example, if a host machine 102 includes two drivers, driver A with a first RIM representing a set of code used for a first CC and driver B with a second RIM representing a set of code used for a second CC, a CPU of the host machine may use the RIMs to communicate one or more vulnerability requests 210 with a verification server 104. To the extent that a security problem is found in driver A but not in driver B (for example, driver B may be even able to address the issue that exists in driver A by being an updated or prior version), then a vulnerability response 214 may cause the first RIM to be revoked to indicate that driver A has a security problem. Driver A will not be trusted against the security claims required to perform a workload. Further, this process may occur behind the scenes and unbeknownst to a user of the host machine 102 or its underlying application 108. Further, the user or application need not know why driver A was revoked and need not have to make a risk decision, which would otherwise require to tear down a multi-day training workload. Such a tear down may be complex and may be costly.

Further, continuing the workload while knowing and accepting the risk to confidential data may lead to further complexities and costs. Therefore, the transaction flow 200 is able to provide information that is direct, in the form of an automatable link in the reference indicators, to remediated driver (such as, driver B, that may already exist or that can be downloaded and applied to a host machine). This allows staging and transition to suitable drivers, when the host machine 102 can autonomously determine a risk involved in using a driver, firmware, and/or GPU configuration is acceptable, for instance.

In at least one embodiment, the transaction flow 200 allows a host machine to use standardized CVE formats (such as, CVE XML from NVD/MITRE) in an automated script to examine contents thereof and to perform a vulnerability analysis. For example, a Common Vulnerability Scoring System (CVSS) analysis may be performed in the host machine 102 automatically. The CVSS may be used to determine if a workload associated with an application 108 should continue or not. This allows for automation of associating information with a digital certificate verification or attestation system. Further, this approach allows for detailed information to be associated for risk analysis with a specific revocation as opposed to having to comb through security bulletins to find the risk information for a digital certificate.

FIG. 3 illustrates further aspects of a system 300 for vulnerability disclosures pertaining to a graphical processing unit (GPU) using an extension field of a status, according to at least one embodiment. In at least one embodiment, a CPU 302 may be a relying party or platform on a workload or application to be performed by a GPU 304. The CPU 302 may rely on an attestation software development kit (SDK) 308 to query the GPU 304 for measurements and to package those measurements for a vulnerability request 310. The attestation SDK 308 also receives the vulnerability response 312. Therefore, the attestation SDK 308 may perform aspects of verification or attestation, as part of a communication with the verification server 104. Further, the attestation SDK 308 may be associated with application programming interfaces (APIs) that may be able to interact with an autonomous script of a host machine 102 to qualify the independent results of the attestation for the GPU 304 or other components of the host machine 102. Further, FIG. 3 is one example of a system 300 using a CPU and a GPU, but such an example system 300 may extend to CPUs able to perform attestation on its behalf, to a CPU able to perform attestation on behalf of another CPU or even a DPU.

The verification server 104 may include multiple modules 314-318 to perform verification, attestation, or validation for a digital certificate associated with the vulnerability request 310. In one example, the modules 314-318 may interface with one or more of the third-party servers described in FIG. 2 but may also interface 320 with other third-party servers providing different services, including for RIM/OCSP/Certficate services 322. Therefore, a verification server may provide signature verification of a signature associated with a vulnerability request 310, whereas the RIM/OCSP/Certficate services 322 can provide signature verification relating to golden measurements from a RIM service and other verifications pertaining to the data retained in a references table 326, for instance. In one example, a first module 314 may provide the signature verification associated with the different third-party servers and the vulnerability request 310. A second module 316 may secure the golden measurements and may perform the calculations associated with the measurements verification. A third module 318 may perform packaging of the responses, including the vulnerability response 312 and the further one or more third-party responses 218, 222. Some or all of such golden measurements and calculations may be retained int eh references table 326 for further or future use.

FIGS. 2 and 3 also illustrate that the information or reference indicator of the vulnerability response 214 may be associated with one or more of a first hyperlink reference to a bulletin from a one or more third-party servers 1 202, 2 204 or a second hyperlink reference. The first hyperlink reference may detail a vulnerability affecting the digital certificate, in the bulletin, for instance. The second hyperlink reference may provide a package to be retrieved to the host machine 102. The package may be installed in the host machine 102 to perform or to provide the modification of the digital certificate.

The host machine 102 may include a first processing unit (which may be a CPU) and a second processing unit (which may be a GPU), with the first processing unit performing the attestation on behalf of the second processing unit. However, it is also possible for a CPU to perform the attestation on behalf of itself or on behalf of another CPU, or a data processing unit (DPU). In one example, the vulnerability request may include measurements associated with the digital certificate and which was returned, via action 324, by the second processing unit to the attestation SDK 308 performed by the first processing unit. The vulnerability request 210; 310 and the modification of the digital certificate can be performed by the first processing unit on behalf of the second processing unit.

The host machine 102 is such that the status indicator of the vulnerability response 214; 312 indicates a revoked status or an unknown status of the digital certificate. However, the host machine can perform or can be triggered to perform the communications with the third-party server based in part on the revoked status or the unknown status because of the information in the extension field. The host machine 102 is also such that it can request, autonomously, a package associated with the digital certificate from the third-party server 1 202; 2 204 using the hyperlink reference of the information or reference indicator. The host machine is such that communications with the third-party server 1 202; 2 204 may be based in part on a hyperlink reference in the information or reference indicator of the vulnerability response 214 and any subsequent third-party response 218.

FIG. 3 also illustrates that the at least one verification server 104 can receive a vulnerability request 310 which may be associated with a digital certificate for operations within a host machine 102. The verification server 104 can determine a status of the digital certificate using at least one of its provided modules 314-318. The verification server 104 can provide a vulnerability response 312 to the host machine 102 after competition of the verification or attestation of the digital certificate. The vulnerability response may include a completion indicator, a status indicator, and an information or reference indicator, and can enable the host machine 102 to use the information or reference indicator to determine a response to a vulnerability associated with the digital certificate or to modify the digital certificate based in part on communications with a third-party server.

Further, the at least one verification server 103 may include reference tables 326 to retain at least first hyperlink references to different and current bulletins from manufacturers as soon as they are issued. For example, the bulletins may be pushed to registered verification servers or may be pulled by periodic queries from the verification server. The bulletins may detail vulnerabilities affecting different digital certificates. Further, while illustrated to use third-party servers 1 202; 2 204, it is possible for the reference tables 326 to also retain second hyperlink references associated with different packages to perform or to provide modifications to one or more digital certificates of the host machine. The third-party servers 1 202; 2 204 may, however, retain the packages to be provided based in part on the first or the second hyperlink references.

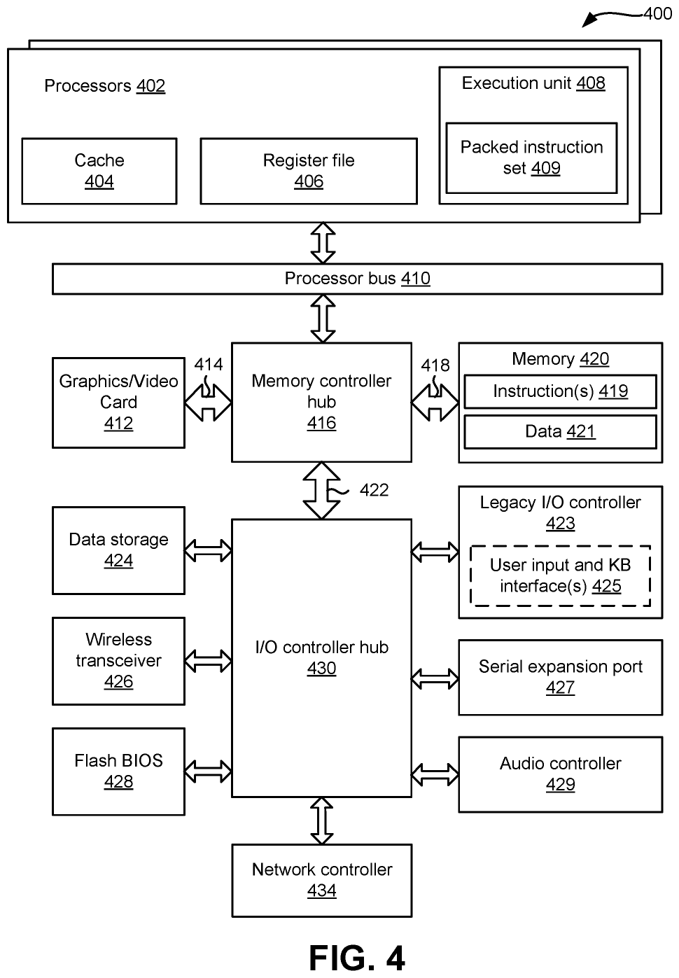

FIG. 4 illustrates computer aspects 400 for vulnerability disclosures for digital certificates using an extension field of a status, according to at least one embodiment. For example, each of the illustrated processors 402 may include one or more processing or execution units 408 that can perform any or all of the aspects of the systems 100, 300 as part of a host machine or even a verification server of FIGS. 1-3 or as part of a host machine or an interconnect device of FIGS. 1-3.

The processing or execution units 408 may include multiple circuits to support the aspects described herein for vulnerability disclosures for digital certificates using an extension field of a status. In at least one embodiment, the processors 402 may include CPUs, GPUs, DPUs that may be associated with a host machine, a NIC, a router, a switch, or a gateway of the interconnect devices in FIGS. 1-3. Further, the GPUs may be distinctly in distinct graphics/video cards 412, relative to a DPU that may be part of a NIC (represented by a network controller 434) and a CPU represented by the processors 402 illustrated in FIG. 4. Therefore, even though described in the singular, the graphics/video card 412 may include multiple cards and may include multiple GPUs on each card that are capable of communications using the protocols in FIGS. 1-3.

The computer and processor aspects 400 may be performed by one or more processors 402 that include a system-on-a-chip (SOC) or some combination thereof formed with a processor that may include execution units to execute an instruction, according to at least one embodiment. In at least one embodiment, the computer and processor aspects 400 may include, without limitation, a component, such as a processor 402 to employ execution units 408 including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processors 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processors 402 may communicate with MCH 416 via processor bus 410. In at least one embodiment, an MCH 416 may provide a high bandwidth memory path 418 to a memory 420 for instruction and data storage and for storage of graphics commands, data, and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414. In at least one embodiment, the graphics/video card 412 may be coupled to one or more of the processors 402 via a PCIe interconnect standard. Similarly, a network controller 424 may also be coupled to one or more of the processors 402 via a PCIe interconnect standard.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processors 402. Examples may include, without limitation, an audio controller 429, a firmware hub (“flash BIOS”) 428, a wireless transceiver 426, a data storage 424, a legacy I/O controller 423 containing user input and keyboard interface(s) 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

Therefore, the at least one execution unit 408 may be a circuit of at least one processor 402 can be associated with a host machine, a NIC, a router, a switch, or a gateway. At least the NIC, router, switch, or gateway which may each be, or which may each support or provide one of the interconnect devices, also described with respect to one or more of FIGS. 1-3. In one example, a system for vulnerability disclosures for digital certificates using the computer aspects 400 in FIG. 4 is enabled in part by a first circuit to transmit a vulnerability request which is associated with a digital certificate for operations within the system. The computer aspects 400 include a second circuit to receive a vulnerability request which is to be used to determine a status of the digital certificate and to be used to provide a vulnerability response. The vulnerability response may include a completion indicator, a status indicator, and an information or reference indicator. The first circuit may use the information or reference indicator to determine a response to a vulnerability associated with the digital certificate or to modify the digital certificate based in part on communications with a third-party server.

In at least one embodiment, the computer aspects 400 in FIG. 4 may be such that the information or reference indicator is an extension field with an Online Certificate Status Protocol (OCSP). Further, the information or reference indicator may be associated with one or more of a first hyperlink reference to a bulletin detailing a vulnerability affecting the digital certificate or a second hyperlink reference providing a package to be retrieved to the host machine. The package may be provided for installation in the host machine to perform or to provide the modification of the digital certificate. Still further, the vulnerability request may include measurements associated with the digital certificate. These measurements may be as returned by the second processing unit to the first processing unit. Such measurements may be returned indirectly between the processing units. For example, an attestation SDK or an API may be used to secure the measurements. The vulnerability request and the modification of the digital certificate may be performed by the first processing unit on behalf of the second processing unit.

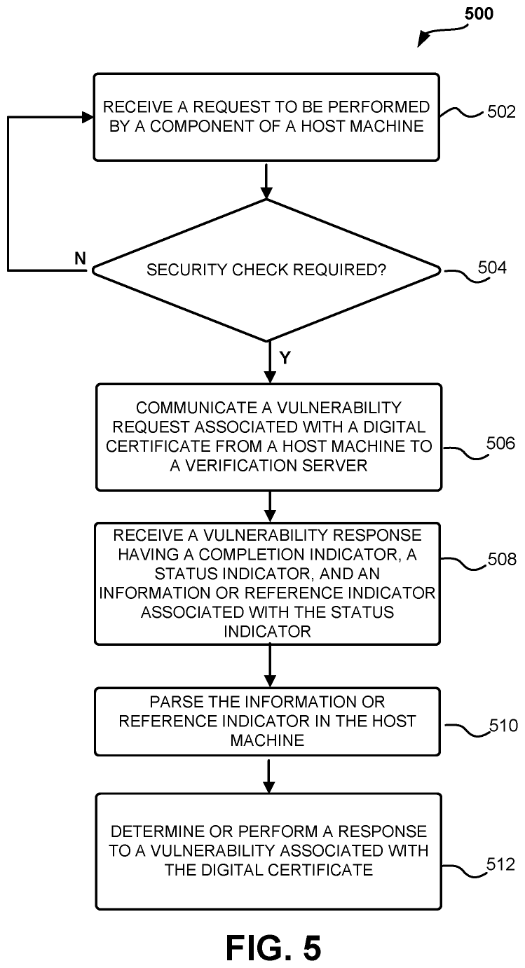

FIG. 5 illustrates a process flow for a system for vulnerability disclosures for digital certificates using an extension field of a status, according to at least one embodiment. The method 500 may include receiving 502 a request which is to be performed by a component of a host machine. The request may be a workload or a job, for instance. The component may be a GPU or its associated driver or firmware. The method 500 may include determining or verifying 504 that a security check is required to perform the request. As part of the security checking, the method 500 may include communicating 506 a vulnerability request associated with a digital certificate from a host machine to a verification server.

The method 500 may include receiving 508 a vulnerability response from the verification server. The vulnerability response may include a completion indicator, a status indicator, and an information or reference indicator associated with the status indicator. The method 500 may include parsing 510 the information or reference indicator in the host machine to perform a subsequent responsive action. For example, using the information or reference indicator in the host machine, a response may be determined as part of an autonomous process for the host machine. As part of the responsive action, the method 500 may include determining or performing 512 a response to the vulnerability response. In one example, the response may be to a vulnerability indicated in a status of the vulnerability response, such as, a revocation of an existing digital certificate or an unknown status for the digital certificate. The response may be to not continue with the request of step 502 or to use a different driver with the request of step 502. Alternatively, the response may be to modify the existing digital certificate based in part on communications with a third-party server.

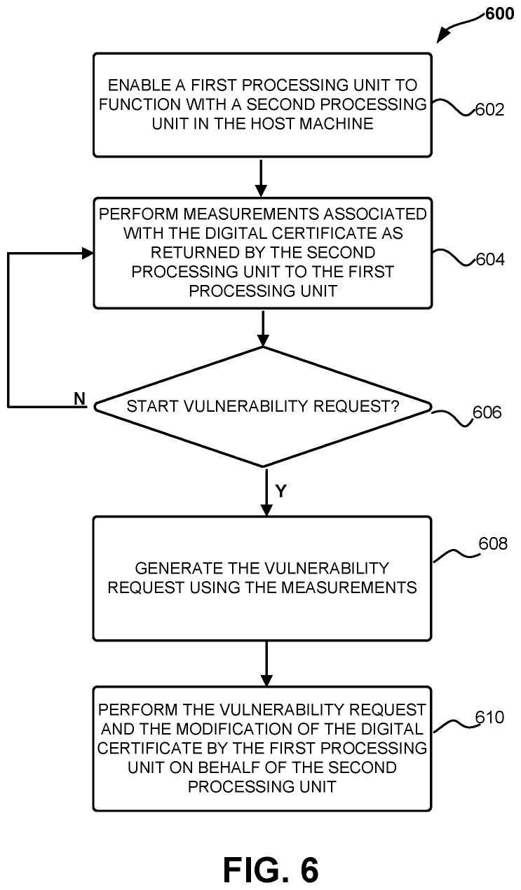

FIG. 6 illustrates a further process flow for a system for vulnerability disclosures for digital certificates using an extension field of a status, according to at least one embodiment. The method 600 may be performed in support or distinctly from the method 500 of FIG. 5. The method 600 in FIG. 6 includes enabling 602 a first processing unit to function with a second processing unit in the host machine. This may be enabled by providing a suitable interface between the processing units, including a PCIe interface and shared memory, for instance. The method may include allowing a CPU, as a first processing unit, to enable buffers in a memory with data, commands, and GPU code. An address of the buffer may be associated in a GPU register. A “doorbell” or other suitable interference logic may be used to enable such associations of a buffer to a GPU register. The GPU can read its associated buffer and can perform commands therein using the data therein or other data shared to it. All such discussion may be also implemented for CPUs alone, for CPU-CPU combination, or for CPU-DPU combinations.

For purposes of vulnerability disclosures, the method 600 includes perform 604 measurements associated with the digital certificate, as returned by the second processing unit to the first processing unit. The method 600 includes determining or verifying 606 a need to perform or to start a vulnerability request. To start or to perform a vulnerability request, the method 600 includes generating 608 the vulnerability request using the measurements. The method 600 includes performing 610 the vulnerability request and the modification of the digital certificate by the first processing unit on behalf of the second processing unit.

The method 600 may be such that the information or reference indicator is an extension field with an Online Certificate Status Protocol (OCSP). The method 600 may be such that the information or reference indicator is associated with one or more of a first hyperlink reference to a bulletin detailing a vulnerability affecting the digital certificate or a second hyperlink reference providing a package to be retrieved to the host machine. The package is to be installed in the host machine to perform or is to provide the modification of the digital certificate.

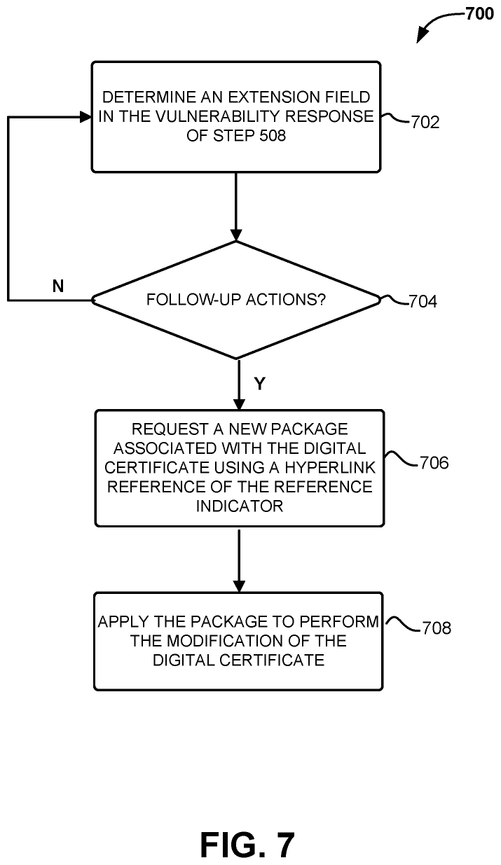

FIG. 7 illustrates yet another process flow for a system for vulnerability disclosures for digital certificates using an extension field of a status, according to at least one embodiment. Like in the case of the method 600 in FIG. 6, the method 700 in FIG. 7 may be performed in support or distinctly from the methods 500, 600 of FIGS. 5 and 6. The method 700 in FIG. 7 includes determining 702 an extension field in the vulnerability response of step 508. In one example, the CPU may be enabled to parse, as in step 510, the vulnerability response to determine that an extension field is provided. Further, the CPU may be able to determine or verify 704 that the information in the extension field is suitable for follow-up actions, including to begin communications with a third-party server. The CPU may determine that the extension field includes a status indicator which indicates a revoked status or an unknown status of the digital certificate. However, the host machine is to perform or is triggered to perform the communications with the third-party server based in part on information in the extension field, upon confirmation that the status is a revoked status or unknown status.

The method 700 includes, as part of the follow-up actions, requesting 706 a package associated with the digital certificate, by the host machine communicating with a third-party server. The third-party server may be provided in a hyperlink reference which is associated with the information or reference indicator. Further, while an initial hyperlink reference may be provided for a bulletin in the information or reference indicator, a second hyperlink reference may be provided in the bulleting to enable a further request, from the host machine, for the package. The method 700 includes applying 708 the package to perform the modification of the digital certificate, as part of the response of step 512.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individualy to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A host machine comprising memory and at least one processor to execute instructions from the memory to cause the host machine to communicate with a verification server using a vulnerability request associated with a digital certificate, to receive and parse a vulnerability response which comprises a completion indicator, a status indicator, and an information or reference indicator associated with the status indicator, and to use the information or reference indicator to determine or perform a response to a vulnerability associated with the digital certificate.

2. The host machine of claim 1, wherein the information or reference indicator is an extension field with an Online Certificate Status Protocol (OCSP).

3. The host machine of claim 1, wherein the information or reference indicator is associated with one or more of a first hyperlink reference to a bulletin detailing a vulnerability affecting the digital certificate or a second hyperlink reference providing a package to be retrieved to the host machine and to be installed in the host machine to perform or to provide the modification of the digital certificate.

4. The host machine of claim 1, the host machine further to comprise a first processing unit and a second processing unit of the at least one processor, wherein the vulnerability request comprises measurements associated with the digital certificate as returned by the second processing unit to the first processing unit, and wherein the vulnerability request and the modification of the digital certificate are to be performed by the first processing unit on behalf of the second processing unit.

5. The host machine of claim 1, wherein the status indicator indicates a revoked status or an unknown status of the digital certificate and wherein the host machine is to perform or is triggered to perform the communications with the third-party server based in part on the revoked status or the unknown status.

6. The host machine of claim 1, wherein the host machine is further to request a package associated with the digital certificate from the third-party server based in part on the hyperlink reference associated with the information or reference indicator and is further to apply the package to perform the modification of the digital certificates.

7. The host machine of claim 1, wherein the response is to modify the digital certificate based in part on communications with a third-party server, the communications based in part on a hyperlink reference associated with the information or reference indicator.

8. A system comprising:
a first circuit to transmit a vulnerability request which is associated with a digital certificate for operations within the system and a second circuit to receive a vulnerability request which is to be used to determine a status of the digital certificate and to be used to provide a vulnerability response comprising a completion indicator, a status indicator, and an information or reference indicator associated with the status indicator, wherein the first circuit is further to use the information or reference indicator to determine or to perform a response to a vulnerability associated with the digital certificate.

9. The system of claim 8, wherein the response is to modify the digital certificate based in part on communications with a third-party server, the communications based in part on a hyperlink reference associated with the information or reference indicator.

10. The system of claim 8, wherein the information or reference indicator is associated with one or more of a first hyperlink reference to a bulletin detailing a vulnerability affecting the digital certificate or a second hyperlink reference providing a package to be retrieved to the host machine and to be installed in the host machine to perform or to provide the modification of the digital certificate.

11. The system of claim 8, wherein the vulnerability request comprises measurements associated with the digital certificate as returned by the second processing unit to the first processing unit, and wherein the vulnerability request and the modification of the digital certificate are to be performed by the first processing unit on behalf of the second processing unit.

12. At least one verification server to receive a vulnerability request which is associated with a digital certificate for operations within a host machine, to determine a status of the digital certificate, and to provide a vulnerability response comprising a completion indicator, a status indicator, and an information or reference indicator to the host machine to enable the host machine to use the information or reference indicator to determine or perform a response to a vulnerability associated with the digital certificate.

13. The at least one verification server of claim 12, wherein the at least one verification server is further to retain one or more of a plurality of first hyperlink references to a plurality of bulletins detailing vulnerabilities affecting different digital certificates or a plurality of second hyperlink references associated with different packages to perform or to provide modifications to one or more digital certificates of the host machine.

14. A method for vulnerability disclosures in digital certificates, the method comprising:
communicating a vulnerability request associated with a digital certificate from a host machine to a verification server;
receiving a vulnerability response from the verification server, the vulnerability response comprising a completion indicator, a status indicator, and an information or reference indicator associated with the status indicator; and
using the information or reference indicator in the host machine to determine or perform a response to a vulnerability associated with the digital certificate.

15. The method of claim 14, wherein the information or reference indicator is an extension field with an Online Certificate Status Protocol (OCSP).

16. The method of claim 14, wherein the information or reference indicator is associated with one or more of a first hyperlink reference to a bulletin detailing a vulnerability affecting the digital certificate or a second hyperlink reference providing a package to be retrieved to the host machine and to be installed in the host machine to perform or to provide the modification of the digital certificate.

17. The method of claim 14, further comprising:
enabling a first processing unit to function with a second processing unit in the host machine;
generating the vulnerability request using measurements associated with the digital certificate as returned by the second processing unit to the first processing unit; and
performing the vulnerability request and the modification of the digital certificate by the first processing unit on behalf of the second processing unit.

18. The method of claim 14, wherein the status indicator indicates a revoked status or an unknown status of the digital certificate and wherein the host machine is to perform or is triggered to perform the communications with the third-party server based in part on the revoked status or the unknown status.

19. The method of claim 14, further comprising:
requesting, by the host machine to the third-party server provided in a hyperlink reference associated with the information or reference indicator, a package associated with the digital certificate; and
applying the package to perform the modification of the digital certificate.

20. The method of claim 14, wherein the response is to modify the digital certificate based in part on communications with a third-party server, the communications based in part on a hyperlink reference associated with the information or reference indicator.
